(19) United States
(12) Patent Application Publication
(10) Pub. No.: US 2008/0038441 A1
(43) Pub. Date: Feb. 14, 2008

(54) Systems and Methods of Brewing Low-Cholesterol Espresso

(75) Inventor: Jonathan Kirschner, Powder Springs, GA (US)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 11/832,112

(22) Filed: Aug. 1, 2007

Related U.S. Application Data
(63) Continuation-in-part of application No. 11/695,157, filed on Apr. 2, 2007.
Application No. 11/695,157 is a continuation-in-part of application No. 10/908,350, filed on May 9, 2005.
Application No. 10/908,350 is a continuation-in-part of application No. 10/604,445, filed on Jul. 22, 2003, now Pat. No. 6,948,420.

(51) Int. Cl. A23F 5/16; A47J 31/043; A47J 31/06

(52) U.S. Cl. 426/594; 99/292; 99/295

(57) ABSTRACT

A low-cholesterol brewed beverage dispenser includes a high-pressure brewing area, a low-pressure area, and a filter. The high-pressure brewing area is configured for brewing water and a brewable material at a relatively high pressure. The low-pressure area is positioned to receive the brewed beverage from the high-pressure brewing area. The pressure in the low-pressure area is relatively lower than the pressure in the high-pressure brewing area. The filter is positioned in the low-pressure area. The filter is configured to remove at least some high-cholesterol oils from the brewed beverage.

### CROSS-REFERENCE TO RELATED APPLICATIONS

This application is a continuation-in-part of the U.S. nonprovisional application entitled “System for Varying Coffee Intensity,” filed on Apr. 2, 2007 and accorded U.S. Ser. No. 11/695,157, which in turn is a continuation-in-part of the U.S. nonprovisional application entitled “Coffee and Tea Pod,” filed on May 9, 2005 and accorded U.S. Ser. No. 10/908,350, which in turn is a continuation-in-part of the U.S. nonprovisional application entitled “Coffee and Tea Pod,” filed on Jul. 22, 2003 and accorded U.S. Ser. No. 10/604,445, now U.S. Pat. No. 6,948,420, all of which are incorporated by reference herein in their entirety.

### TECHNICAL FIELD

The present application generally relates to systems and methods of brewing espresso, and more particularly relates to systems and methods of brewing relatively low-cholesterol espresso.

### BACKGROUND

Espresso is a type of beverage made by forcing water through ground coffee beans at high pressure to extract solids and oils from the coffee beans. The solids and oils become dispersed throughout and emulsified with the water. The result is a thick and flavorful beverage that is normally consumed shortly after extraction or is mixed with other liquids to form an espresso-based beverage. For example, an “americano” is an espresso-based beverage made by mixing espresso with water while cappuccino is a espresso-based beverage made by mixing espresso, milk, and milk foam.

Espresso and espresso-based beverages tend to be high in cholesterol. Coffee beans may include high-cholesterol oils that are extracted along with the other solids and oils during the brewing process and become incorporated into the espresso. Terpenes, for example, are oils found in coffee beans that tend to contain LDL cholesterol. The presence of high-cholesterol oils such as terpenes in espresso may be undesirable to individuals who want to limit the intake of cholesterol for health reasons. For example, LDL cholesterol in particular has been shown to increase the risk of diseases such as heart disease, among others.

### SUMMARY

The present application describes a low-cholesterol brewed beverage dispenser. The low-cholesterol brewed beverage dispenser includes a high-pressure brewing area, a low-pressure area, and a filter. The high-pressure brewing area is configured for brewing water and a brewable material at a relatively high pressure. The low-pressure area is positioned to receive the brewed beverage from the high-pressure brewing area. The pressure in the low-pressure area is relatively lower than the pressure in the high-pressure brewing area. The filter is positioned in the low-pressure area. The filter is configured to remove at least some high-cholesterol oils from the beverage.

The present application further describes a method of making relatively low-cholesterol espresso. The method includes brewing espresso at a relatively high pressure, reducing the pressure of the espresso, and filtering the espresso to remove at least some of the high-cholesterol oils from the espresso.

The present application also describes a pod cartridge. The pod cartridge includes a sidewall, a base, and a filter. The sidewall defines an interior space. The base separates the interior space into a brewing area and an accumulation area. The brewing area is configured for brewing espresso at a relatively high pressure and the accumulation area is configured for allowing the espresso to return to a lower pressure. The filter is positioned in the accumulation area. The filter is configured to remove at least some high-cholesterol oils from the espresso after the pressure of the espresso has been lowered.

Other systems, devices, methods, features, and advantages of the disclosed systems and methods will become apparent to one with skill in the art upon examination of the following figures and detailed description. All such additional systems, devices, methods, features, and advantages are intended to be included within the scope of the description, as protected by the accompanying claims.

### BRIEF DESCRIPTION OF THE DRAWINGS

The present disclosure may be better understood with reference to the following drawings. Matching reference numerals designate corresponding parts throughout the drawings, and components in the drawings are not necessarily to scale.

FIG. 1 is a perspective view of one embodiment of a beverage dispenser system for use with the present invention.

FIG. 2 is a top plan view of the beverage dispenser system of FIG. 1.

FIG. 3 is a perspective view of a turret system of the beverage dispenser system of FIG. 1.

FIG. 4 is a perspective view of an injector assembly of the beverage dispenser system of FIG. 1, with the guide wheels and the return spring of the support plate shown in phantom lines.

FIG. 5 is a rear perspective view of the injector assembly of the beverage dispenser system of FIG. 1, with the idler wheel and the limit switch shown in a cut away view.

FIG. 6 is perspective view of a pod as described herein.

FIG. 7 is perspective view of a pod as described herein.

FIG. 8 is a side cross-sectional view of the pod of FIG. 6.

FIG. 9 is a top perspective view of the pod of FIG. 6.

FIG. 10 is a bottom perspective view of the pod of FIG. 6.

FIG. 11 is a side cross-sectional view of a pod showing the lid.

FIG. 12 is a side cross-sectional view of a pod cartridge with an amount of brewing material positioned therein.

FIG. 13 is a side plan view of an alternative embodiment of the lip of the pod of FIG. 6.

FIG. 14 is a side cross-sectional view of the pod of FIG. 13.

FIG. 15 is a side plan view of a grinder for use with the invention as described herein.

FIG. 16 is a side plan view of an embodiment of a low-cholesterol espresso dispenser.

FIG. 17 is a perspective view of an embodiment of a pod cartridge that can be used with the beverage dispenser system of FIGS. 1-5.

FIG. 18 is a perspective view of the pod cartridge shown in FIG. 17.

FIG. 19 is a cross-sectional view of the pod cartridge shown in FIG. 17, taken along line 19-19.

FIG. 20 is a block diagram illustrating an embodiment of a method of making relatively low-cholesterol espresso and espresso-based beverages.

### DETAILED DESCRIPTION

Commonly owned U.S. Pat. No. 6,786,134, entitled “COFFEE AND TEA DISPENSER” is incorporated by reference herein in its entirety.

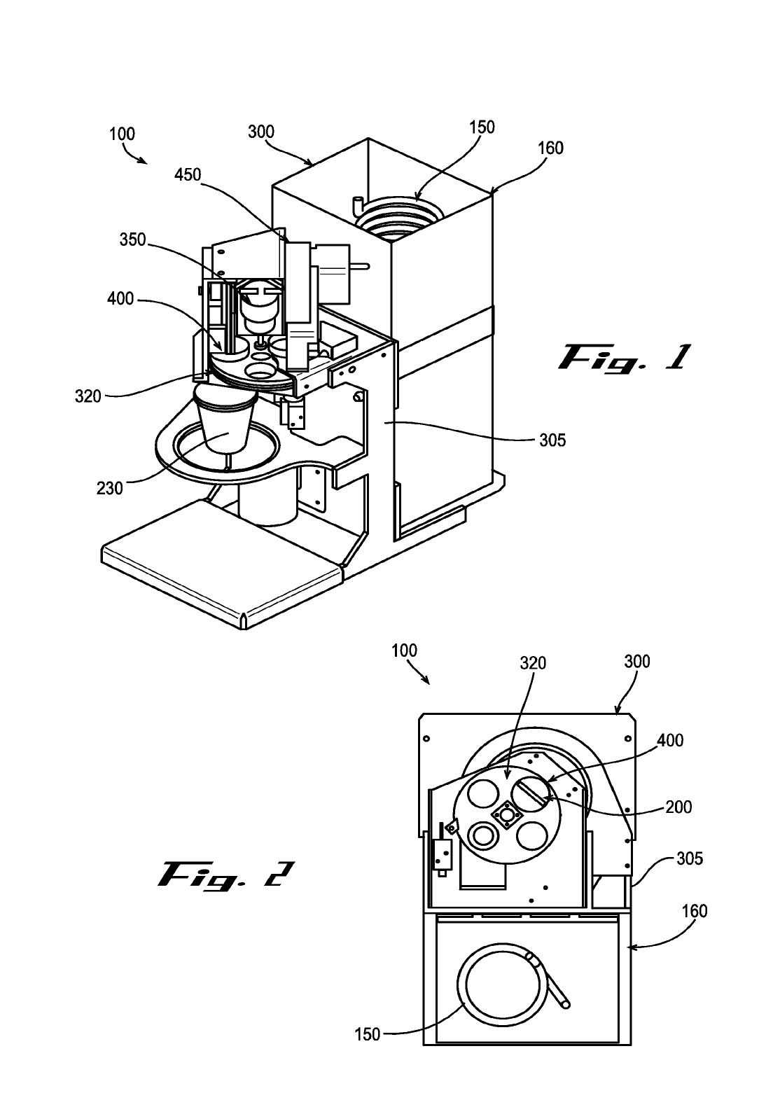

Referring now to the drawings, in which like numerals refer to like elements throughout the several views, FIGS. 1 and 2 show one application of a beverage dispenser system 100. In these figures, a pod brewing apparatus 300 is shown. The pod brewing apparatus 300 may include a heat exchanger 150 positioned within a hot water reservoir 160 and in communication with an injection nozzle 200 as is shown. In this embodiment, the elements of the beverage dispenser system 100 as a whole are mounted onto a dispenser frame 305. The dispenser frame 305 may be made out of stainless steel, aluminum, other types of metals, or other types of substantially noncorrosive materials.

The injection nozzle 200 may interact with one or more pod cartridges 210 so as to produce the desired beverage in a cup 230 or any other type of receptacle. The pod cartridges 210 may be positioned in the beverage dispenser system 100 within a turret assembly 310. The turret assembly 310 may be fixedly attached to the dispenser frame 305. As is shown in FIG. 3, the turret assembly 310 may include a turret plate 320 positioned within a turret frame 325. The turret frame 325 may be made out of stainless steel, aluminum, other types of conventional metals, or similar types of substantially noncorrosive materials. The turret plate 320 may be substantially circular or have any convenient shape. The turret plate 320 may include a number of pod apertures 330. The pod apertures 330 may be sized to accommodate the pod cartridges 210. The turret plate 320 may spin about a turret pin 340. A turret motor 350 may drive the turret assembly 310. The turret motor 350 may be a conventional AC motor or a similar type of device. The turret motor 350 may drive the turret assembly 310 at about six (6) to about thirty (30) rpm, with about twenty-five (25) rpm preferred.

The turret plate 320 also may have a number of detents 360 positioned about its periphery. The detents 360 may be positioned about each of the turret apertures 330. The detents 360 may cooperate with one or more limit switches 365 so as to control the rotation of the turret plate 320. The rotation of the plate 320 may be stopped when the limit switch 360 encounters one of the detents 360. Rotation of the plate 320 may be controlled by similar types of devices.

Positioned adjacent to the turret assembly 310 may be an injector assembly 400. The injector assembly 310 may be fixedly attached to the dispenser frame 305. The injector assembly 400 also may include an injector frame 410 extending above the turret assembly 310. The injector frame 410 may be made out of stainless steel, other types of metals, or similar types of substantially noncorrosive materials.

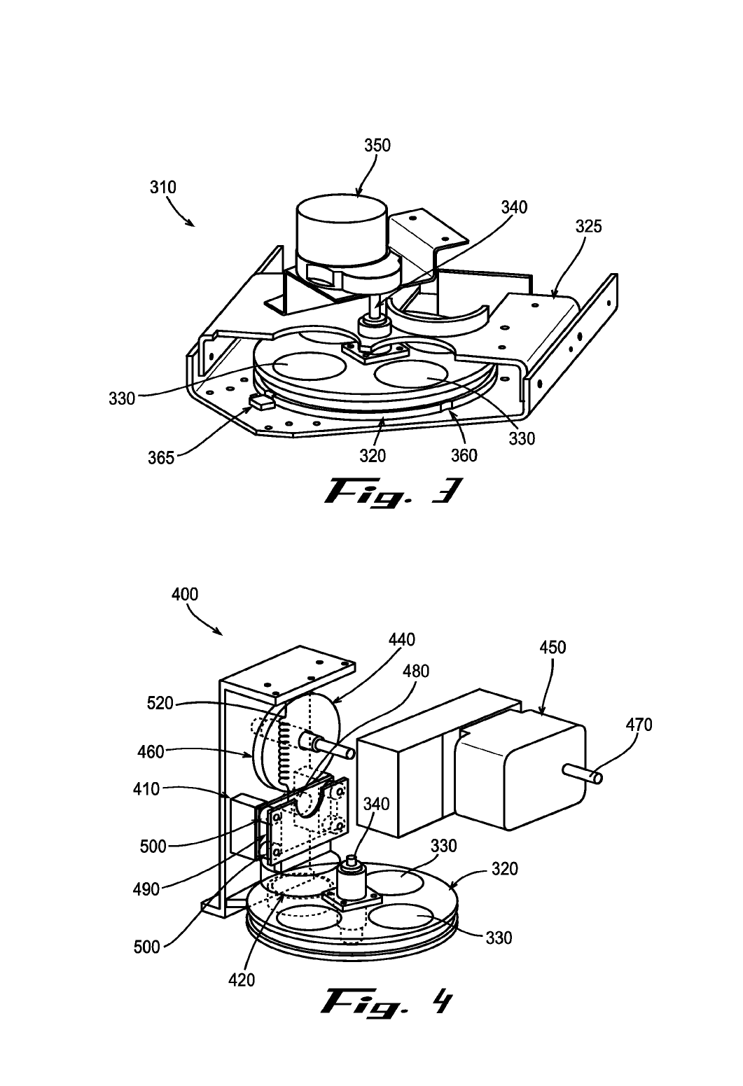

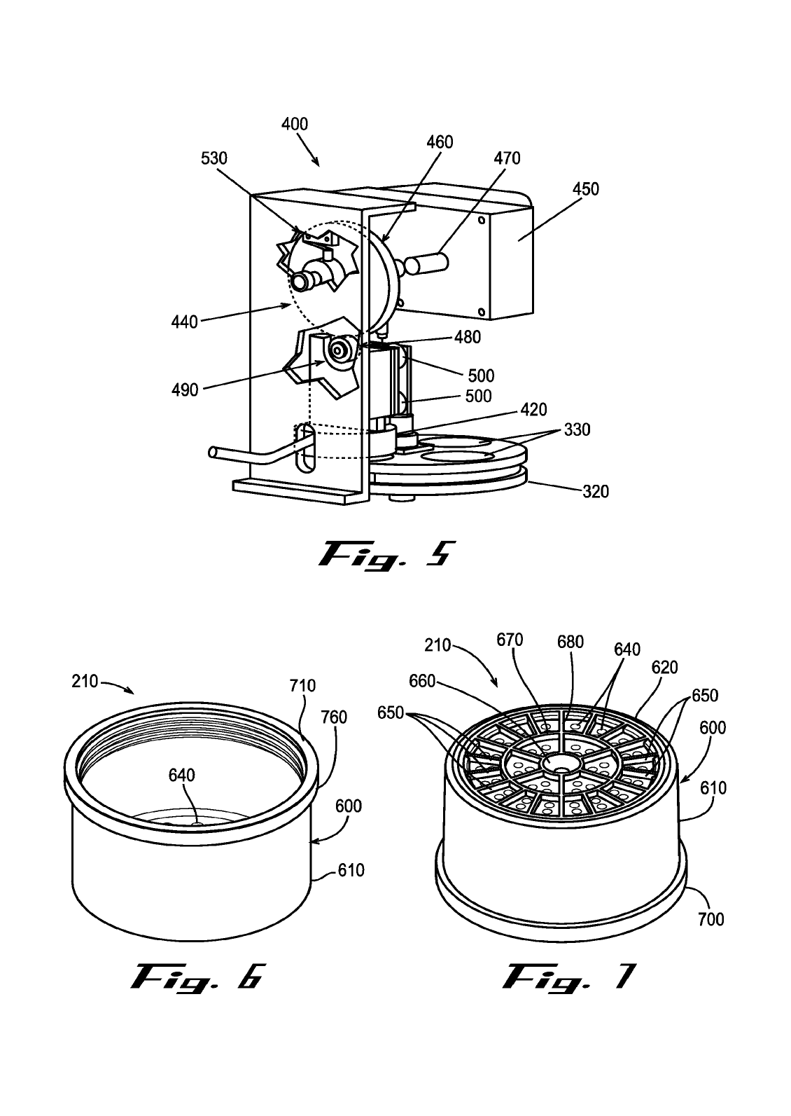

Referring now to FIGS. 4 and 5, the injector assembly 400 may include the injection nozzle 200 as described above with respect to FIG. 2. The injection nozzle 200 may have a narrow tip so as to penetrate the pod cartridge 210 if needed or a wide mouth to accommodate the entire pod cartridge 210. The injector assembly 400 may include an injector head 420 that cooperates with the injection nozzle 200. The injector head 420 may be slightly larger in diameter than the pod cartridges 210. The injector head 420 also may be made out of stainless steel plastics, or similar types of substantially noncorrosive materials. The injector head 420 may include a sealing ring positioned about its lower periphery. The sealing ring may be made out of rubber, silicone, or other types of elastic materials such that a substantially water tight seal may be formed between the injector head 420 and the pod cartridge 210. The heat exchanger 150 may be in communication with the injector head 420 so as to provide hot, pressurized water to the pod cartridges 210.

The injector head 420 may be moveable in a substantially vertical plane via a cam system 440. (The terms “vertical” and “horizontal” are used as a frame of reference as opposed to absolute positions. The injector head 420 and the other elements described herein may operate in any orientation.) A cam system drive motor 450 may drive the cam system 440. The drive motor 450 may be a conventional AC motor similar to the turret motor 350 described above. The drive motor 450 also may be a shaded pole or a DC type motor. The drive motor 450 may rotate an eccentric cam 460 via a drive belt system 470. The drive motor 450 and the gear system 470 may rotate the eccentric cam 460 at about six (6) to about thirty (30) rpm, with about twenty-five (25) rpm preferred. The eccentric cam 460 may be shaped such that its lower position may have a radius of about 4.1 to about 4.8 centimeters (about 1.6 to 1.9 inches) while its upper position may have a radius of about 3.5 to 4.1 centimeters (about 1.3 to about 1.7 inches).

The eccentric cam 460 may cooperate with an idler wheel 480. The idler wheel 480 may be in communication with and mounted within a support plate 490. The support plate 490 may maneuver about the injector frame 410. The support plate 490 may be made out of stainless steel, other types of steel, plastics, or other materials. The support plate 490 may be fixedly attached to the injector head 420. The support plate 490 may have a number of guide wheels 500 positioned thereon such that the support plate 490 can move in the vertical direction within the injector frame 410. A return spring 520 also may be attached to the support plate and the injector frame 410. A limit switch 530 may be positioned about the cam 460 such that its rotation may not exceed a certain amount.

The injector head 420 thus may maneuver up and down in the vertical direction via the cam system 440. Specifically, the drive motor 450 may rotate the eccentric cam 460 via the gear system 470. As the eccentric cam 460 rotates with an ever-increasing radius, the idler wheel 480 pushes the support plate 490 downward such that the injector head 420 comes in contact with a pod cartridge 210. The eccentric cam 460 may lower the injector head 420 by about 6.4 to about 12.7 millimeters (about one-quarter to about one-half inch). Once the injector head 420 comes into contact with the pod cartridge 210, the eccentric cam 460 may continue to rotate and increases the pressure on the pod cartridge 210 until the cam 460 reaches the limit switch 530. The injector head 420 may engage the pod cartridge 210 with a downward force of about 136 to 160 kilograms (about 300 to 350 pounds). The sealing ring thus may form a substantially airtight and water tight seal about the pod cartridge 210. The drive motor 450 may hold the cam 460 in place for a predetermined amount of time. The cam system 440 then may be reversed such that the injector head 420 returns to its original position.

Once the injection nozzle 200 of the injector head 420 is in contact with the pod cartridge 210, the hot, high pressure water may flow from the heat exchanger 150 into the injector head 420. The pressure of the water flowing through the pod cartridge 210 may vary with the nature of the brewing material 550 therein.

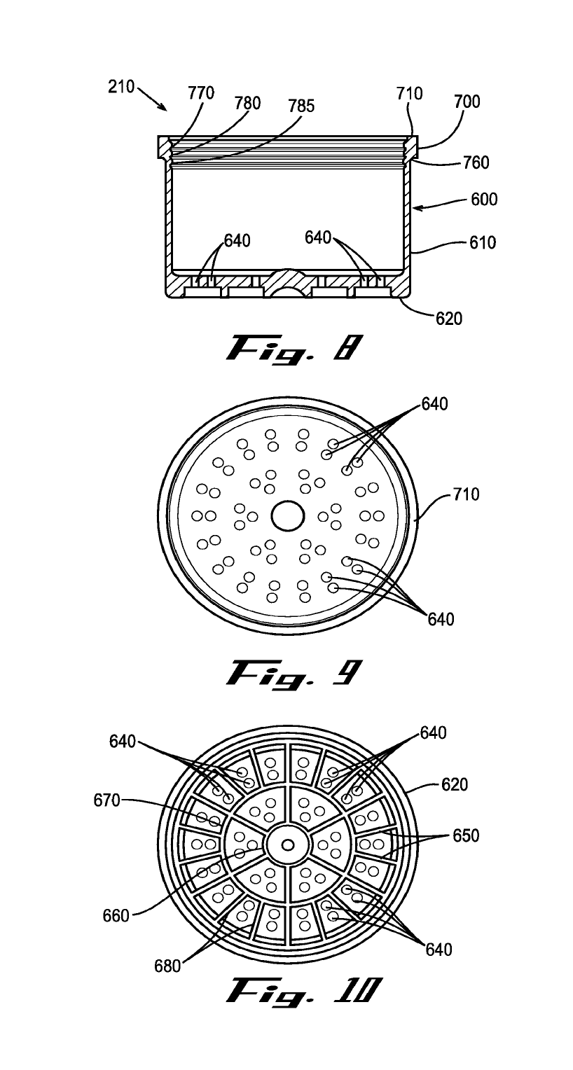

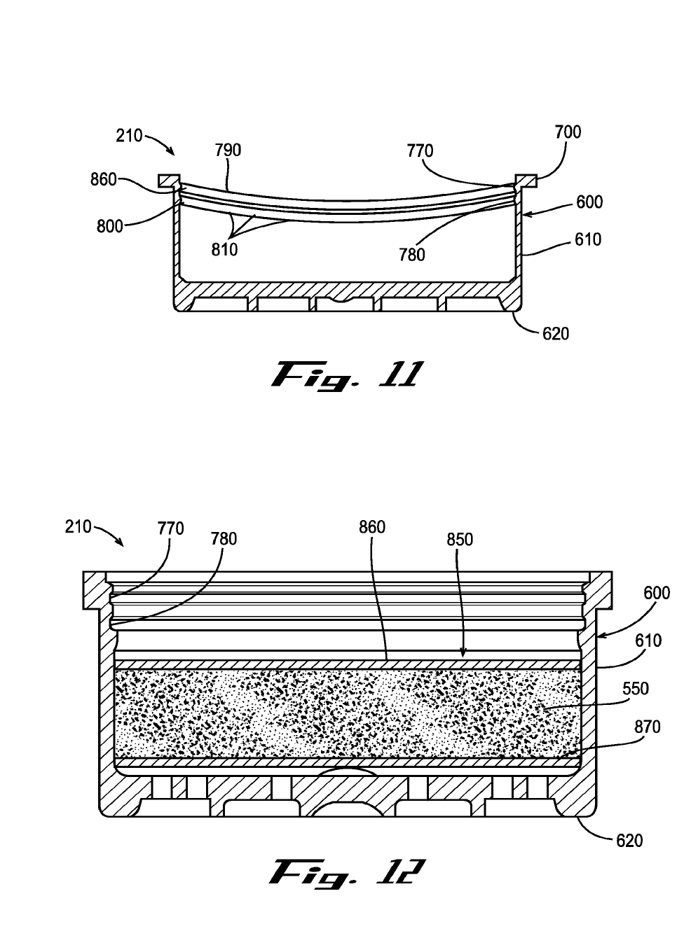

FIGS. 6-12 show an embodiment of the pod cartridge 210 that may be used with the beverage dispenser system 100 or other types of beverage systems. In fact, the pod cartridge 210 may be used with any type of mixable material, flavoring, additives, and other substances. The pod cartridge 210 may be substantially in the shape of a cup 600. The cup 600 may be made out of a conventional thermoplastic such as polystyrene, polyethylene, polypropylene and similar types of materials. Alternatively, stainless steel or other types of substantially non-corrosive materials also may be used. The cup 600 may be substantially rigid so as to withstand the heat and pressure of the brew cycle without imparting any off-tastes. As described below, however, by the term “rigid” we mean that the cup 600 may flex or deform slightly while under pressure.

The cup 600 may include a substantially circular sidewall 610 and a substantially flat base 620. Other shapes also may be used. The sidewall 610 and the base 620 of the cup 600 may be molded and form a unitary element or a separate sidewall 610 and a separate base 620 may be fixably attached to each other The sidewall 610 and the base 620, as well as the cup 600 as a whole, may have any convenient diameter so as to accommodate the pod apertures 330 of the turret plate 320 of the turret assembly 310 and the injector head 420 of the injector 400. Alternatively, the sidewall 610 and the base 620 of the cup 600 may have any convenient diameter so as to accommodate other types of beverage dispenser systems 100 or similar types of devices.

By way of example, the sidewall 610 may have an inside diameter of about 39.3 millimeters (about 1.549 inches) with a wall thickness of about 1.1 millimeters (about 0.043 inches). The sidewall 610 may have a slight taper from the top to the bottom. Other sizes or dimensions may be used as desired. The cup 600 as a whole may have a variable depth depending upon the amount of brewing material intended to be used therein. In the case of the cup 600 intended to be used for about a 355 milliliter (about twelve (12) ounce) beverage, the cup 600 may have a total height of about 28.7 millimeter (about 1.13 inches) and a useable inside height of about 17.1 millimeters (about 0.674 inches). The height to diameter ratio for the 355 milliliter cup 600 therefore may be about 0.73 for the total height and about 0.435 for the usable inside height. The cup 600 may have about 6.4 grams of a polypropylene material.

A cup 600 to be used with, for example, about a 237 milliliter (about an eight (8) ounce) beverage may have a height of about 22.5 millimeters (about 0.887 inches) and a usable inside height of about 11.8 millimeter (about 0.463 inches). The ratio thus may be about 0.57 for the total height and about 0.3 for the usable inside height. The cup 600 may have about 5.8 grams of a polypropylene material.

These ratios between diameter and depth provide the cup 600 and the cartridge 210 as a whole with sufficient strength and rigidity while using a minimal amount of material. The cartridge 210 as a whole may have about five (5) to about eight (8) grams of plastic material therein when using, for example, a polypropylene homopolymer. As a result, the cup 600 and the cartridge 210 as a whole may withstand temperatures of over about 93 degrees Celsius (about 200 degrees Fahrenheit) for up to sixty (60) seconds or more at a hydraulic pressure of over about ten (10) bar (about 150 pounds per square inch). Although the cup 600 having these ratios may flex or deform somewhat, the cup 600 and the cartridge 210 as a whole should withstand the expected water pressure passing therethough. These dimensions and characteristics are for the purpose of example only. The sidewall 610 and the base 620 of the cup 600 may take any desired or convenient size or shape. For example, the sidewall 610 may be straight, tapered, stepped, or curved if desired.

The base 620 may include a number of apertures 640 formed therein. The apertures 640 may extend through the width of the base 620. The apertures 640 may be largely circular in shape with a diameter each of about 1.6 millimeters (about 0.063 inches). Any desired shape or size, however, may be used. In this embodiment, about 54 apertures 640 are used herein, although any number may be used. The selected number and size of apertures 640 provide the appropriate pressure drop when a cup 600 of a given dimension is used.

The base 620 also may have a number of support ribs 650 positioned thereon. An inner circular rib 660, an outer circular rib 670, and a number of radial ribs 680 may be used. In this embodiment, the ribs 650 may have a depth of about one (1) millimeter (about 0.04 inches), although any desired thickness may be used. Likewise, any desired number and/or shape of the ribs 650 may be used. The design of the ribs 650 also provides increased support and stability to the cartridge 210 as a whole with a minimum amount of material.

The sidewall 610 of the cup 600 also may include an upper lip 700. The upper lip may include a substantially flat top portion 710. The flat top portion 710 may have a width of about 3.45 millimeters (about 0.136 inches) and a height in the vertical direction of about 3.4 millimeters (about 0.135 inches). The lip 700 may be configured to accommodate the size of the pod apertures 330 and the injector head 420 as well as the expected force of the hot water provided by the injector head 420 while using as little material as possible. This is particularly true given that the cartridge 210 as a whole generally is supported only about its lip 700 during the injection process.

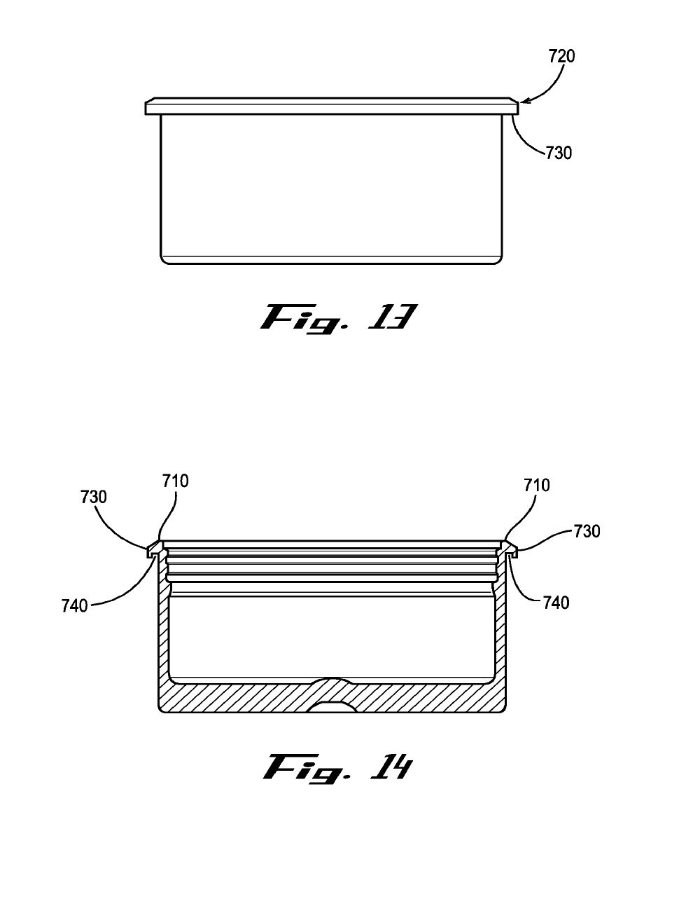

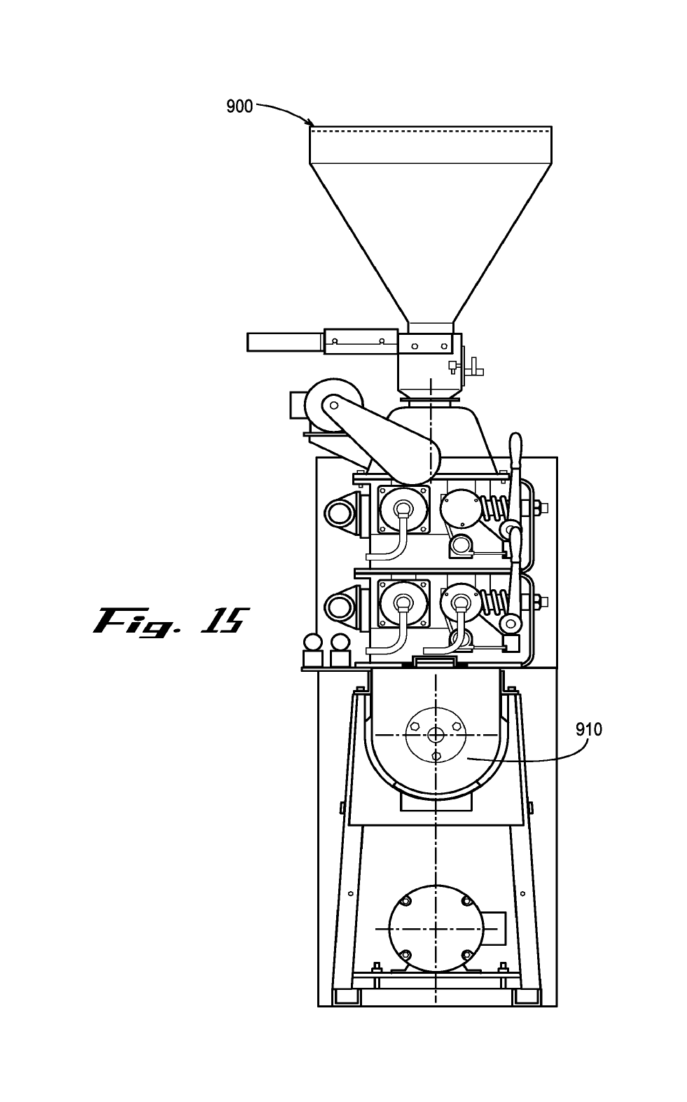

FIGS. 13 and 14 show an alternative embodiment of the lip 700. In this embodiment, a lip 720 may include the substantially flat top portion 710 and a downwardly angled flanged 730 that extends from the top portion 730. The flange 730 may extend downward so as to form a pocket 740 with the sidewall 610. The top of the pocket 740 may have a curved inner radius. The flange 730 and the pocket 740 of the lip 720 are sized to accommodate the size of the pod apertures 330.

Referring again to FIGS. 6-12, the sidewall 610 of the cup 600 also may include a number of cutouts 760 formed therein. In this embodiment, a first cutout 770, a second cutout 780, and a third cutout 785 may be used. Any number of cutouts 760, however, may be used. For example, only two (2) cutouts 760 may be used with a 237 milliliter (about an eight (8) ounce) cup 600. The cutouts 760 may be continuous around the inner circumference of the sidewalls 610 or the cutouts 760 may be intermittent.

The cutouts 760 may cooperate with a lid 790. The lid 790 may have an edge 800 that is substantially wedge-shaped about its perimeter for insertion within a cutout 760. The use of the cutouts 760 ensures that the lid 790 remains in place. The edge 800 may be continuous or intermittent so as to mate with the cutouts 760. The lid 790 preferably is bowed inwardly or may be largely concave in shape. The lid 790 may have about 0.8 grams of a polypropylene material.

The lid 790 may be placed in one of the cutouts 760 depending upon the amount of brewing material that is to be placed in the cup. The lid 790 may be bowed downward in a concave shape so as to tap the brewing material 550 down under pressure and to keep the brewing material therein from shifting. The lid 790 may provide the correct tamp force to the brewing material 550 and holds the material under load via essentially a Bellville washer principle. The use of the lid 790 to tamp the brewing material 550 also permits a faster fill rate when loading the cup 600 with the brewing material 550. The lid 790 also may have a number of apertures 810 therein so as to permit water from the injector head 420 to pass therethrough. Depending upon the nature of the injector head 420, the use of the lid 790 may not be necessary.

The cup 600 may be lined with one or more layers of a filter paper 850. The filter paper 850 may be standard filter paper used to collect the brewing material 550 while allowing the beverage to pass therethrough. The filter paper 850, however, should have sufficient strength, stiffness, and/or porosity such that it does not deflect into the apertures 640 of the base 620 and/or allows fine particles of the brewing material 550 to close or clog the apertures 640. Clogging the apertures 640 may create an imbalance in the pressure drop though the cartridge 210. Because of the stiff paper 850 that substantially resists deformation, the apertures 640 of the base 620 of the cup 600 may have a somewhat larger diameter for increased flow therethrough.

For example, the filter paper 850 may be made with a combination of cellulose and thermoplastic fibers. Examples of suitable filter papers 850 are sold by J. R. Crompton, Ltd. of Gainesville, Ga. under the designations PV-377 and PV 347C. For example, the PV-347C material may have a grammage of about forty (40) grams per square meter and a wet burst strength of about 62 kilopascals. Similar types of materials may be used. Multiple sheets of paper also may be used. The multiple sheets each may have the same or differing characteristics.

The pod cartridge 210 may have an upper filter layer 860 and a lower filter layer 870. The lower filter layer 860 is generally positioned therein without the use of adhesives. The upper filter layer 860 may not need as much strength as the lower layer 870. The upper filter layer 860 generally provides water dispersion and prevents the grinds from clogging the injector head 420. The brewing material 550 itself may be positioned between the upper and lower filter layers 860, 870. Preferably, the brewing material 550 is in direct contact with the sidewall 610, i.e., there is no filter paper 850 position around the inner diameter of the cup 600. This positioning forces the water to travel through the brewing material 550 itself as opposed to traveling through the cup 600 via the filter paper 850.

The brewing material 550 may be placed within a foil envelope or other type of substantially air impermeable barrier. The foil envelope 590 may serve to keep the brewing material 550 therein fresh and out of contact with the ambient air. Alternatively, the entire pod cartridge 210 may be placed within a foil envelope, either individually or as a group, until the cartridge 210 is ready for use.

The brewable material 550 itself usually is prepared in a grinder 900. The grinder 900 may take the raw material, coffee beans in this example, and grind them into coffee grinds. As is shown in FIG. 15, the grinder 900 preferably is a roller grinder. An example of such a grinder 900 is manufactured by Modem Process Equipment, Inc. of Chicago, Ill. under the designation of model 660FX. A roller grinder 900 is preferred over other types of grinders such as a burr grinder. The roller grinders seem to provide better particle size distribution, i.e., the particle size distribution is more consistent. The roller grinder 900 provides fewer large particles that may tend to under-extract and provide off tastes and fewer “fines” or very small coffee particles that tend to alter the taste of the final beverage by over-extracting and contributing to bitterness. Limiting fines also has an effect on the back pressure within the pod cartridge 210 as the back pressure is inversely proportional to the square of the particle size. The back pressure thus increases as the particle size decreases.

A comparison between a roller grinder and a burr grinder is shown below. The roller grinder particle distribution (the “Rainforest” grind with the spike to the left) ends at about the 8.0 μm particle size while the burr grinder (the “Milano” grind with the spike to the right) continues to about the 0.1 μm particle size. Likewise, there are fewer larger particles with the roller grinder:

[image]

As is shown, over eighty percent (80%) of the grinds ground with the roller grinder 900 have a particle size distribution between about 220 and about 250 microns (micrometers) with over ninety-nine percent (99%) having a particle size distribution between about eight (8) Micron and 650 microns. Broadly, over seventy-five percent (75%) percent of the coffee grinds may have a particle size distribution of between about 200 and about 300 microns. Although a consistent particle size distribution of around 250 microns provides an improved beverage, a certain amount of fine particles also may be desired so as to provide the resistance and desired pressure during brewing. The lack of enough fines may allow the water to pass through too quickly. As such, ten (10) to twenty (20) percent of the distribution may be in about the forty micron range.

In order to control the number of fines and to control the back pressure and resistance, an evaluation of the particle size of the smallest ten percent (10%) (d(0.1)) may be used. The smaller this number is, the greater the percentage of the particles that are smaller than a given diameter. The position of d(0.1) is shown below:

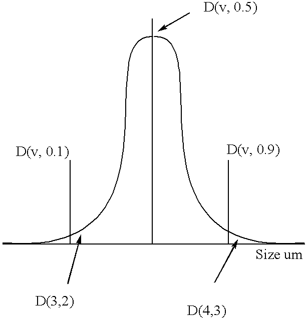

Generally speaking and by way of example, d(0.1)of about 43 microns maybe acceptable while 25 micron may be unacceptable.

A similar approach is to look at the surface area mean diameter. The surface area mean diameter is useful because as particle size decreases, the surface area to volume ratio quickly increases. The surface area mean diameter is calculated by multiplying each particle diameter by the total surface area of material in all particles of that size, summing, and dividing by the total surface area of all particles. Thus, for a diameter at the coordinates of 3,2 shown above, the calculation is:

$$D [ 3 , 2 ] = \frac{\sum {D}_{i}^{3} {n}_{i}}{\sum {D}_{i}^{2} {n}_{i}}$$

Generally speaking and by way of example, a surface area mean diameter at D[3,2] of 116 microns may be acceptable while a diameter of 78 microns may not be acceptable.

Similar calculations may be made that focus on the presence of larger particles. For example, the volume mean diameter D [4,3] also may be calculated:

$$D [ 4 , 3 ] = \frac{\sum {D}_{i}^{4} {n}_{i}}{\sum {D}_{i}^{3} {n}_{i}}$$

The roller grinder 900 thus provides a narrower and more consistent particle size distribution. Similarly, the number of fines can be monitored so as to limit bitterness while maintaining a consistent pressure therethrough. Such a particle size distribution provides a coffee beverage with improved and consistent taste.

The grinder 900 also may include a densifier 910. The densifier 910 may include a number of blades so as to form the individual grinds into a more uniform size and shape. Specifically, the grinds seem to be have a more uniform spherical shape and seem to be somewhat hardened. Densification of the grinds results in changing the brew characteristics in that the increase in density changes the nature of the water flow through the grinds.

In addition to creating substantially uniform spheres, the densifier 920 also seems to reduce the number of fines or small particles by “sticking” the smaller particles to the larger particles. The sticking may be due to the oils in the grinds, the work added to the grinds, or other causes. For example, with densification, solids in the coffee may about six (6) percent. Without densification, however, the solids may reach about 7.5 percent, which provides a finished product that may be too strong. The net result is a smaller, more uniform particle size distribution. Although densification has been used to improve the packing of coffee, densification has not been employed so as to change the brew characteristics of the grinds.

In use, the lower layer 870 of filter paper may be placed with the cup 600 of the pod cartridge 210 along the base 620. An amount of the brewing material 550 then may be positioned therein. The upper layer 860 of the filter paper then may be placed on the brewing material 550 if desired. The lid 790 then may be placed within the cup 600 so as to tamp down the brewing material 550 with about 13.6 kilograms of force (about thirty (30) pounds of force). The amount of force may vary. Once the lid 790 has compacted the brewing material 550, the edge 800 of the lid 790 is positioned within the appropriate cutout 760 within the sidewall 610 of the cup 600. The pod 210 then may be sealed or otherwise shipped for use with the beverage dispenser system 100 or otherwise.

The pod 210 may be positioned within one of the pod apertures 330 in the turret assembly 310. Specifically, the outer edge of the pod aperture 330 aligns with the lip 700 of the cup 600 such that the cup 600 is supported by the lip 700. The injector head 420 then may be positioned about the pod 210. The sealing ring of the injector head 420 may seal about the top portion 710 of the lip 700 of the cup 600. The use of a rounded lip or a lip with a non-flat shape may cause damage to the sealing ring given the amount of pressure involved, i.e., as described above, the injector head 420 may engage the pod cartridge 210 with a downward force of about 136 to about 160 kilograms of force (about 300 to about 350 pounds) and the incoming water flow may be pressurized at about ten (10) to about fourteen (14) bar (about 145 to 200 pounds per square inch (psi)). The pressure of the water flowing through pod cartridge 210 may vary with the nature of the brewing material 550. The hot pressurized water may be provided to the cartridge 210 from any source.

The water passing through the injection head 420 may spread out over the lid 790 and the apertures 810 thereof and into the brewing material 550. The nature of the water flow through the cartridge 210 as a whole depends in part upon the geometry and size of the cartridge 210, the nature, size, and density of the brewing material 550, the water pressure, the water temperature, and the brew time. Altering any of these parameters may alter the nature of the brewed beverage. The brewed beverage may then pass through the apertures 640 in the base 620 of the cup 600.

As is shown in FIG. 12, the pod cartridges 210 may be filled with different types of grinds, leaves, or other types of a brewing material 550. In the case of a single serving espresso beverage of about thirty-five (35) milliliters, about six (6) to about eight (8) grams of specially ground coffee may be placed in the pod cartridge 210. Likewise, the same amount of ground coffee may be used to brew an American style coffee with the addition of about 180 milliliters (about six (6) ounces) of water. About two (2) to about five (5) grams of tealeaves may be added to the pod cartridge 210 in order to brew about a 180 milliliter (about six (6) ounce) cup of tea. 10072Each different type of coffee or other type of brewing material 550 has a different size grind. For example, one coffee bean may be ground to about 500 to 800 particles for a typical drip filter-type coffee. The same coffee bean may be ground to over 3500 particles for an espresso grind. The particles themselves have different sizes and weights.

Maintaining particle size uniformity, as described above, is preferred. Coffee grind particles that are not the correct size will generally over extract or under extract the soluble solids out of the coffee. The use of the grinder 900 helps to ensure a more consistent particle size. The use of the densifier 910 also assists in providing particle size uniformity. Tamping the coffee grinds down assists in providing uniform fluid flow through the cup 600. As described above, particle size relates to the back pressure that does the “work” of brewing the beverage.

With respect to brew time and temperature, brew temperatures are typically in the range of about 85 to about 100 degrees Celsius (about 185 to about 212 degrees Fahrenheit) or sometimes warmer at about 10 to about 14 bar. The water within the hot water reservoir 160 may be heated to about 102 degrees Celsius (about degrees 215.6 degrees Fahrenheit) by the heat exchanger 150. The water loses some of its heat as it passes thought the injector head 420 and into the cartridge 210.

By way of example, a “Roma” espresso beverage as described above, may use the 237 milliliter (eight (8) ounce) cartridge 210 with about six (6) grams of coffee grinds therein. The cartridge 210 may produce about thirty-five (35) milliliters of the beverage. The water may leave the hot water reservoir 160 at about 102 degrees Celsius (about degrees 215.6 degrees Fahrenheit) and have a brew time of about eight (8) seconds (plus or minus two (2) seconds) at about eleven (11) bar. (Densification of the grinds may speed up the brew time and reduce the amount of extracted materials.) The 355 milliliter (twelve (12) ounce) cartridge 210 also could be used if the lid 790 is placed in a lower cutout 760. A “Dark” beverage has similar properties, but uses about 7.3 grams of the grinds. As a result, the brew time is about fourteen (14) seconds.

A “Rain Forest” beverage also may use the 237 milliliter (eight (8) ounce) cartridge 210 with about six (6) grams of grinds therein. These grinds, however, are coarser than the Roma grinds, such that the flow rate through the cartridge 210 may be faster. Hence the brew time would be about seven (7) seconds (plus or minus two (2) seconds). A certain amount of make up water (about 180 milliliters) also may be added to the beverage after brewing. An “Americano” beverage may use the espresso grinds described above with the various grinds and blends having differing characteristic and tastes.

As is shown, the cartridge 210 also may be used to brew tea. In this example, about 2.8 grams of tealeaves may be used. As opposed to the traditional method of seeping tea over several minutes, this example about a 210 milliliter (about seven (7) ounce) beverage may be brewed in about 6.2 seconds. Iced tea also may be brewed with the addition of an amount of make-up water.

Various examples of the brewing parameters are shown below:

| | Coffee I | | Coffee II | | Coffee III | | Coffee IV | | Tea | |
|---|---|---|---|---|---|---|---|---|---|---|
| Type | Roma | | Dark | | Rainforest | | Breakfast | | Chai | |
| | | | | | | | Blend | | | |
| Particle | 255 | μm | 250 | μm | 250 | μm | 255 | μm | | |
| size | | | | | | | | | | |
| Pod size | 8 | ounce | 8 | ounce | 8 | ounce | 8 | ounce | 8 | ounce |
| Weight | 6 | grams | 7.3 | grams | 6 | grams | 6.75 | grams | 2.8 | grams |
| Density | 0.378 | g/ml | 0.371 | g/ml | 0.425 | g/ml | 0.425 | g/ml | 0.426 | g/ml |
| Water | 102° | C. | 102° | C. | 102° | C. | 102° | C. | 102° | C. |
| temperature | | | | | | | | | | |
| Pressure | 11 | Bar | 11 | Bar | 11 | Bar | 11 | Bar | 11 | Bar |
| Brew time | 8.0 | seconds | 14.0 | seconds | 7.0 | seconds | 8.9 | seconds | 6.2 | seconds |

| | | | | | | |
|---|---|---|---|---|---|---|
| Beverage | 35 ml for | 35 ml for | 210 ml for | 210 ml for | 210 | ml |
| size | espresso; 210 | espresso; 210 | Americano | Americano | | |
| | ml for | ml for | | | | |
| | Americano; | Americano; | | | | |
| | Cappuccino | Cappuccino | | | | |
| | has 4 ounces | has 4 ounces of | | | | |
| | of foamed | foamed milk; | | | | |
| | milk; Lattes | Lanes have 6 | | | | |
| | have 6 | ounces of hot | | | | |
| | ounces of hot | milk | | | | |
| | milk | | | | | |

The combination of the variables described herein thus provides a pod cartridge 210 that produces a beverage with a consistent taste. Specifically, the beverage taste is consistent across the use of any number of cartridges 210.

Consumers also are interested in coffee and other types of beverages that may vary in flavor intensity and/or strength. As such, it is desirable to offer specific beverages in low, medium, and high intensity. Such varying intensity may be possible by maintaining the same grade or type of beans, roasting characteristics, particle size distribution, i.e., the same grind profile, and other types of brewing parameters, but varying the gram weight of the grinds positioned therein

In other words, a consistent type of grind may be used for a particular type of coffee beverage. For example, the mean particle size distribution of a particular type of coffee may remain between about 200 to about 300 microns. Specifically, about seventy-five to about eighty-five percent (75-85%) of the coffee grinds may have a mean particle size distribution of about 250 microns with the remainder being fines, i.e., grinds with a particle size distribution of less than about 100 microns.

Depending upon the desired intensity of the beverage, the gram weight of the grinds may be varied. For example, a low intensity beverage may have about six (6) grams of the grinds while a high intensity beverage may have about 7.5 grams of the grinds for a typical eight (8) ounce coffee beverage. A medium intensity beverage would fall somewhere in between. Varying the amount of coffee also varies the brew time with more material requiring a longer brew time. At the specific particle size distribution, the pod cartridge 210 has the correct quantity of fine particles to restrict water flow therethrough so as to provide coffee extracts with a desired ratio of aromatics and flavor with the bitter compounds that are characteristic to coffee.

Certain grinds also are found to “bloom” at specific gram weights. In other words, certain flavors/aroma attributes are intensified or optimized at a particular gram weight given the mean particle size. Representative blends in all three categories of low, medium, and high flavor intensities thus may be found.

Thus, the same grinding techniques, particle size distribution, and other brewing parameters may be used for each type of coffee beverage while the intensity may be varied simply with varying the gram weight. The present system thus provides a vast number of beverages with varying intensities but with highly repeatable performance. Variation on the gram weight also applies to brewable materials in addition to coffee such a tea leaves. Brewable, soluable, dispersible, and other types of materials also may be used.

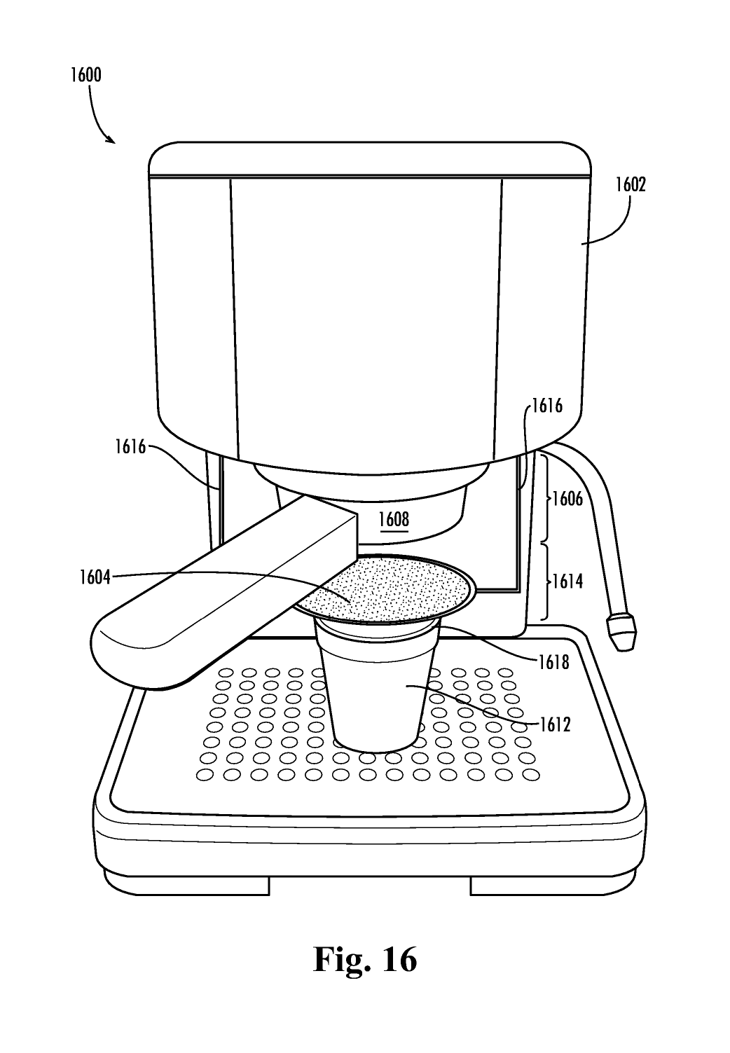

FIG. 16 is side plan view of an embodiment of a low-cholesterol espresso dispenser 1600. The low-cholesterol espresso dispenser 1600 generally may include an espresso brewing system 1602 and at least one filter 1604. The espresso brewing system 1602 may be configured to brew espresso at a relatively high pressure. The filter 1604 may be configured to filter the espresso at a relatively low pressure after the espresso is brewed. The relatively low pressure ensures at least some of the high-cholesterol oils in the espresso are retained by the filter 1604 instead of being forced through the filter 1604.

The espresso brewing system 1602 can be any system that brews espresso at a relatively high pressure. More specifically, the espresso brewing system 1602 has a high-pressure brewing area 1606 in which coffee beans and water interact. The relatively high pressure in the high-pressure brewing area 1606 causes the solids and oils to be extracted from the coffee beans and to be dispersed throughout the water. Thus, espresso is created. For purposes of this disclosure, the term “high pressure” generally denotes a pressure above atmospheric pressure that is suited for extracting solids and oils from coffee beans. The high pressure may be a pressure of about 3 bars to about 15 bars or higher, depending on the embodiment.

The espresso brewing system 1602 may be any type of conventional espresso machine, including a super-automatic espresso machine, an automatic espresso machine, a semi-automatic espresso machine, a manual espresso machine, a stove-top espresso maker, and similar types of devices. Typically, conventional espresso machines employ a high pressure between about 9 bars and about 10 bars within a brewing area 1608. As shown in FIG. 16, the espresso brewing system 1602 may be a semi-automatic espresso machine, and the brewing area 1608 may be a conventional portafilter. The portafiler may be similar to that described in commonly-owned U.S. patent application Ser. No. 11/160,531, filed on Jun. 28, 2005, incorporated herein by reference.

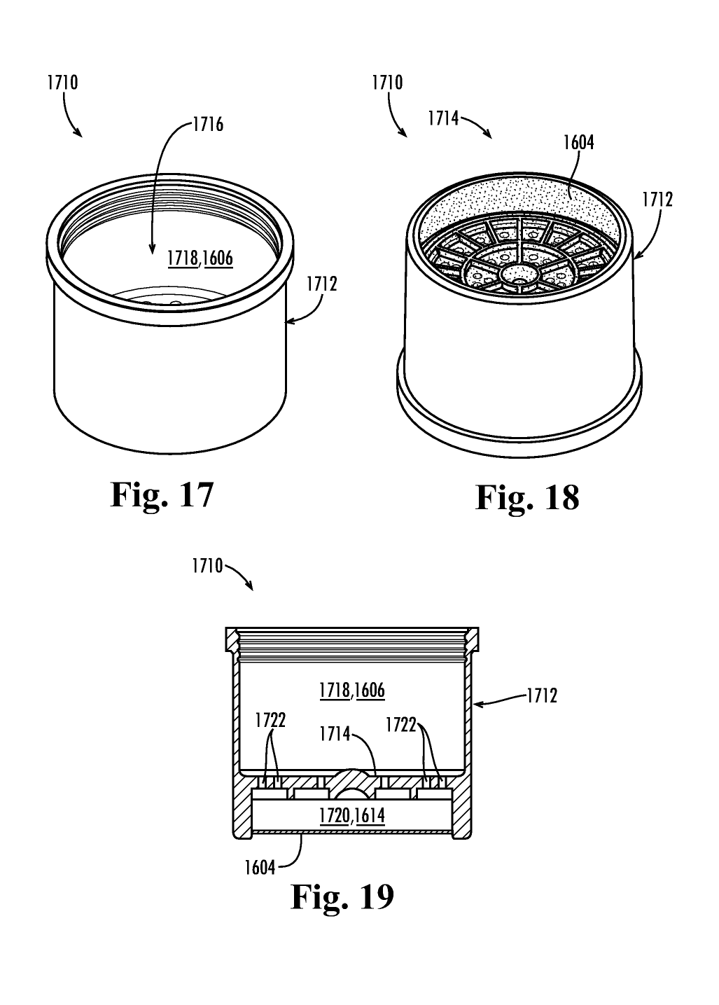

Alternatively, the espresso brewing system 1602 may be an embodiment of the beverage dispenser system 100 described above with reference to FIGS. 1-14. In such case, the beverage dispenser system 100 employs a pod cartridge 1710. The pod cartridge 1710 is described below with reference to FIGS. 17-19. The pod cartridge 1710 may have a brewing area 1718, and the beverage dispenser system 100 employs a high pressure of about 11 bars within the brewing area 1718. In still other embodiments, other espresso brewing systems 1602 can be used. Additionally, other high pressures can be employed to vary the flavor and consistency of the resulting espresso.

The high-pressure brewing area 1606 of the espresso brewing system 1602 may have an exit 1610. Once the espresso is brewed, the espresso travels from the high-pressure brewing area 1606 through the exit 1610 and into a container 1612, such as the cup 230 described above. The container 1612 receives the espresso from the exit 1610 and holds the espresso at about atmospheric pressure so that the espresso can be consumed. A relatively low-pressure area 1614 is formed between the exit 1610 of the high-pressure brewing area 1606 and the container 1612. The espresso passes through the low-pressure area 1614 after exiting the high-pressure brewing area 1606 and before entering the container 1612. For the purposes of this disclosure, the term “low pressure” generally denotes a pressure that is relatively lower than the high pressure used to brew the espresso.

For example, the low-pressure area 1614 may be an area between the high-pressure area brewing area 1606 and the container 1612 that is exposed to the atmosphere. In such cases and in other cases, the low pressure in the low-pressure area 1614 may be about atmospheric pressure. The espresso may move through the low-pressure area 1614 under the force of gravity. In the embodiment shown in FIG. 16, the espresso descends from the brewing area 1608, through the low-pressure area 1614, and into the container 1612 under the force of gravity. In the embodiment shown in FIGS. 17-19, the espresso descends from a brewing area 1718 of the pod cartridge 1710, through the low-pressure area 1614, and into the container 1612 under the force of gravity. In other embodiments, the espresso may be moved through the low-pressure area 1614 under a pressure that exceeds the force of gravity yet is relatively lower than the pressure in the high-pressure brewing area 1606.

To form the low-cholesterol espresso dispenser 1600, at least one filter 1604 is position about the low-pressure area 1614 of the espresso brewing system 1602. The filter 1604 is configured to remove high-cholesterol oils from the espresso. Because the filter 1604 is positioned in the low-pressure area 1614, the filter 1604 can capture at least some of the high-cholesterol oils that would be forced through the filter 1604 at high pressure. Therefore, the cholesterol content of the espresso may be reduced. Although only one filter 1604 is shown, additional filters 1604 may be employed as desired.

More specifically, the filter 1604 may be positioned anywhere in the low-pressure area 1614. In some embodiments, the filter 1604 may be positioned adjacent the exit 1610 of the high-pressure brewing area 1606. For example, the filter 1604 may be positioned within the pod cartridge 1710, as described below with reference to FIGS. 17-19. In other embodiments, the filter 1604 may be positioned somewhere between the exit 1610 of the high-pressure brewing area 1606 and an entrance 1618 into the container 1612. Such positioning is shown in FIG. 16. As shown, the filter 1604 may be positioned on suspension arms 1616 that hang downward from the espresso brewing system 1602. In still other embodiments, the filter 1604 may be positioned adjacent the entrance 1618 into the container 1612. For example, the filter 1604 may be a permanent filter that is rested on the entrance 1618 of the container 1612 before the espresso is brewed, and is set aside for future use after the espresso is brewed. The filter 1604 also may be a disposable filter 1604 that is coupled to the entrance 1618 of the container 1612 before the espresso is brewed, and is detached and discarded after the espresso is brewed. In embodiments in which the filter 1604 is positioned somewhere between the exit 1610 of the high-pressure brewing area 1606 and the entrance 1618 into the container 1612, or in cases in which the filter 1604 is positioned adjacent the entrance 1618, the filter 1604 may have a concavity. The concavity may enable the espresso to accumulate above the filter 1604. For example, the espresso may descend at a rate that exceeds the rate at which the espresso can pass through the filter 1604. In such cases, the concavity provides an area where the espresso can accumulate before passing through the filter 1604.

Any filter 1604 having a porosity and a material suited to remove at least some of the high-cholesterol oils from the espresso can be used. For example, the filter 1604 may be formed from a paper material, a cloth material, a metallic material, a ceramic material, or any other material or combination thereof. The material of the filter 1604 may be suited to separate the high-cholesterol oils from the espresso. In some embodiments, the filter 1604 may be formed from a material having an affinity for high-cholesterol oils so that the high-cholesterol oils are attracted to the filter 1604. In some embodiments, the filter 1604 may be configured to remove at least some of the terpenes from the espresso, so that the LDL cholesterol content of the espresso is reduced. In such embodiments, the filter 1604 has a porosity selected to remove at least some of the terpenes.

The filter 1604 may be disposable or permanent, depending on the embodiment. Filters 1604 that are disposable may be used one time or a few times before being replaced. Filters 1604 that are permanent may be permanently integrated into the espresso brewing system 1602. Such filters 1604 also may be removably integrated into the espresso brewing system 1602, so that espresso can be brewed without removing the high-cholesterol oils when desired.

FIGS. 17 and 18 are perspective views of an embodiment of a pod cartridge 1710. FIG. 19 is a cross-sectional view of the pod cartridge 1710 taken along line 19-19. The pod cartridge 1710 may be an embodiment of the pod cartridge 210, which is generally described above with reference to FIGS. 6-14. The pod cartridge 1710 may be used with the beverage dispenser system 100, which is generally described above with reference to FIGS. 1-5.

Like the pod cartridge 210, the pod cartridge 1710 maybe configured for brewing espresso at a relatively high pressure. In addition, however, the pod cartridge 1710 may include the filter 1604 configured to remove at least some high-cholesterol oils from the espresso at relatively low pressure.

More specifically, the pod cartridge 1710 may include the sidewall 1712 and the base 1714. The sidewall 1712 defines an interior space 1716. The base 1714 separates the interior space 1716 into a brewing area 1718 and an accumulation area 1720. The brewing area 1718 may be the high-pressure brewing area 1606 where the coffee beans and water interact. The accumulation area 1720 may be the low-pressure area 1614 where the espresso is filtered.

More specifically, the brewing material 550 and the filter paper 850 may be placed in the brewing area 1718, as described above. The base 1714 has apertures 1722 that form the exit 1610 from the brewing area 1718 into the accumulation area 1720. The filter 1604 may be positioned at an end 1724 of the accumulation area 1720 opposite from the base 1714. The accumulation area 1720 is sized to allow the espresso to accumulate in the accumulation area 1720 at a relatively low pressure. Therefore, the pressure of the espresso is reduced before the espresso reaches the filter 1604. The espresso then passes through the filter 1604 when exiting the accumulation area 1720, so that at least some of the high-cholesterol oils in the espresso are captured.

More specifically, the injector assembly 400 begins forcing water through the brewing area 1718 when the brewing process begins. The freshly-brewed espresso begins flowing into the accumulation area 1720 through the apertures 1722 and out of the accumulation area 1720 through the filter 1604. The flow rate of the espresso into the accumulation area 1720 may exceed the flow rate of the espresso out of the accumulation area 1720 because the filter 1604 tends to impede the espresso. Therefore, the espresso may accumulate in the accumulation area 1720. However, the sizing of the accumulation area 1720 ensures the espresso is under relatively lower pressure in the accumulation area 1720 than in the brewing area 1718. Otherwise, if the accumulation area 1720 is too small, the espresso may be subjected to a backpressure that forces the high-cholesterol oils through the filter 1604. For example, the accumulation area 1720 may have a volume selected so that the volume of the accumulation area 1720 exceeds a volume of espresso in the accumulation area 1720 at any point in the brewing process. The espresso can then accumulate freely at a relatively low pressure, such as atmospheric pressure.

The sizing of the accumulation area 1720 may be adjusted based on the configuration of the apertures 1722 and the filter 1604. More specifically, the flow rate into the accumulation area 1720 may be determined by the apertures 1722 while the flow rate out of the accumulation area 1720 may be determined by the filter 1604. However, the apertures 1722 and the filter 1604 are not primarily configured to achieve the desired flow rate. Instead, the apertures 1722 are primarily configured to achieve an appropriate high pressure in the brewing area 1718, while the filter 1604 is primarily configured to provide the appropriate filtration of high-cholesterol oils. For example, the apertures 1722 may have a certain size, number, and distribution across the base 1714 while the filter 1604 may have a certain porosity. Because the apertures 1722 and the filter 1604 have configurations selected for reasons other than achieving the desired flow rate, the sizing of the accumulation area 1720 may be adjusted.

As shown in FIG. 19, the sidewall 1712 of the pod cartridge 1710 may be extended in comparison with the sidewall of the pod cartridge 210 shown in FIG. 8. Extending the sidewall 1712 increase the volume of the accumulation area 1720 For example, the sidewall 1712 may be extended so that the espresso freely descends into the accumulation area 1720 and returns to about atmospheric pressure before being filtered. In such cases, the beverage dispenser system 100 may include a turret assembly 310 having pod apertures 1722 that can accommodate the pod cartridge 1710 with the extended sidewall 1712. The support ribs on the pod cartridge 1710 may or may not be extended in such cases.

In the illustrated embodiment, the pod cartridge 1710 may be disposable. In such embodiments, the filter 1604 may be a disposable material such as paper. The filter 1604 may be coupled to an interior surface of the sidewall 1712 adjacent a lower edge below the support ribs. For example, the filter 1604 may be welded to the sidewall 1712. For the purposes of this disclosure, the term “welded” generally denotes the filter 1604 is secured to the sidewall 1712 by applying heat where the filter 1604 and the sidewall 1712 intersect. The heat causes the materials used to form the filter 1604 and the sidewall 1712 to commingle, forming a secure connection. In other embodiments, the filter 1604 may be attached at other positions or in other manners.

The low-cholesterol espresso dispenser 1600 may be configured to brew both regular espresso and low-cholesterol espresso. For example, the beverage dispenser system 100 may be configured for use with both the pod cartridge 210 and the pod cartridge 1710 having the filter 1604. A user wishing to drink regular espresso may select the pod cartridge 210 while a user wishing to drink low-cholesterol espresso may select the pod cartridge 1710. The user may make the selection via a button or control on the low-cholesterol espresso dispenser 1600. The user may be influenced not only by health requirements but also by taste, as filtered espresso may have a different taste than unfiltered espresso.

The low-cholesterol espresso dispenser 1600 may be further configured to incorporate the espresso into an espresso-based beverage. Espresso-based beverages are coffee beverages made by extracting espresso under high pressure and subsequently mixing the espresso with other liquid, such as water, milk, or chocolate. Example espresso-based coffee beverages include americano, cappuccino, latte, and mocha, among others. In such embodiments, the low-cholesterol espresso dispenser 1600 may filter the espresso before or after the espresso is mixed with the other liquids. For example, in FIG. 16 the espresso brewing system 1602 may mix the espresso with other liquids and the resulting espresso-based beverage may then pass through the filter 1604 into the container 1612.

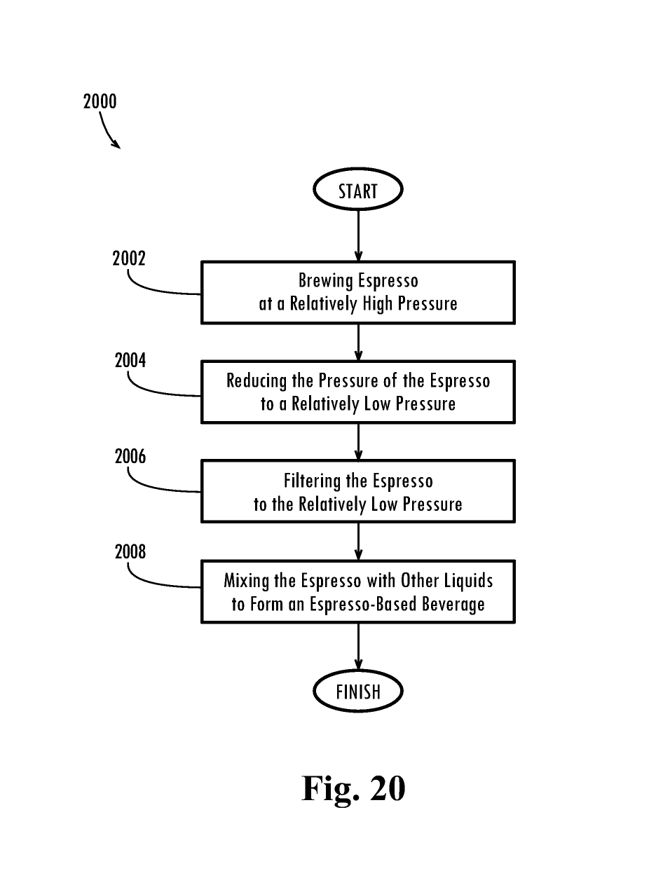

FIG. 20 is a block diagram illustrating an embodiment of a method of making relatively low-cholesterol espresso and espresso-based beverages. In block 2002, the espresso is brewed under a relatively high pressure, such as a high pressure in the range of about 3 bars to about 15 bars. For example, a high pressure of about 9 bars to about 10 bars may be used to brew the espresso in a conventional espresso machine, or a high pressure of about 11 bars may be used to brew the espresso using the beverage dispenser system 100. In block 2004, the pressure of the espresso is reduced to a relatively low pressure. The low pressure is relatively lower than the high pressure used to extract the espresso and may be atmospheric pressure. The pressure of the espresso may be reduced to the low pressure by allowing the espresso to descend from a high-pressure brewing area into a low-pressure area, such as an area at atmospheric pressure. For example, the pressure of the espresso may be reduced to the low pressure by allowing the espresso to descend from the high pressure brewing area into an accumulation area of a pod cartridge. In block 2006, the espresso is filtered at the relatively low pressure to remove at least some of the high-cholesterol oils from the espresso. Filtering the espresso at the relatively low pressure allows at least some of the high-cholesterol oils to be removed from the espresso. For example, the espresso may be filtered by allowing the espresso to descend through a filter.

In some embodiments, the espresso may be mixed with one or more other liquids to form an espresso-based beverage in block 2008. For example, the espresso may be mixed with water to form americano, or milk to form cappuccino. It should be noted that the espresso is filtered in block 2006 after the espresso is brewed in block 2002 and the pressure is reduced in block 2004. However, the espresso may be mixed with other liquids in block 2008 either before or after the pressure is reduced in block 2004 and the espresso is filtered in block 2006.

Although particular embodiments of systems and methods of brewing low-cholesterol espresso have been disclosed in detail in the foregoing description and figures for purposes of example, those skilled in the art will understand that variations and modifications may be made without departing from the scope of the disclosure. All such variations and modifications are intended to be included within the scope of the present disclosure, as protected by the following claims and equivalents.

1. A low-cholesterol brewed beverage dispenser comprising:
a high-pressure brewing area configured for brewing water and a brewable material at a relatively high pressure to create a brewed beverage;
a low-pressure area positioned to receive the brewed beverage from the high-pressure brewing area, the pressure in the low-pressure area being relatively lower than the pressure in the high-pressure brewing area; and
a filter positioned about the low-pressure area, the filter being configured to remove at least some high-cholesterol oils from the brewed beverage.

2. The low-cholesterol brewed beverage dispenser of claim 1, wherein the filter comprises a material adapted to separate at least some of the high-cholesterol oils from the brewed beverage.

3. The low-cholesterol brewed beverage dispenser of claim 1, wherein the filter is positioned adjacent an entrance into a container.

4. The low-cholesterol brewed beverage dispenser of claim 1, wherein the filter is positioned between the high-pressure brewing area and an entrance into a container.

5. The low-cholesterol brewed beverage dispenser of claim 1, wherein the pressure in the high-pressure brewing area is about 3 bars to about 15 bars.

6. The low-cholesterol brewed beverage dispenser of claim 1, wherein:
the pressure in the high-pressure brewing area is about 9 bars to about 11 bars; and
the pressure in the low-pressure area is about atmospheric pressure.

7. The low-cholesterol brewed beverage dispenser of claim 1, wherein:
the high-pressure brewing area comprises a brewing area of a pod cartridge; and
the low-pressure area comprises an accumulation area of the pod cartridge, the accumulation area being sized to allow the brewed beverage from the brewing area to return to atmospheric pressure before being filtered.

8. The low-cholesterol brewed beverage dispenser of claim 7, wherein the pod cartridge comprises:
a sidewall that defines an interior space; and
a base that separates the interior space into the brewing area and the accumulation area, the base comprising a plurality of apertures that allow the brewed beverage to flow from the brewing area into the accumulation area.

9. A method of making relatively low-cholesterol espresso, the method comprising:
brewing espresso at a relatively high pressure;
reducing the pressure of the espresso; and
filtering the espresso to remove at least some high-cholesterol oils from the espresso.

10. The method of claim 9, wherein brewing the espresso at a relatively high pressure comprises brewing the espresso at a pressure between about 3 bars and about 15 bars.

11. The method of claim 9, wherein:
brewing the espresso at a relatively high pressure comprises brewing the espresso at a pressure between about 9 bars and about 11 bars; and
reducing the pressure of the espresso comprises allowing the espresso to return substantially to about atmospheric pressure.

12. The method of claim 9, wherein:
brewing the espresso at a relatively high pressure comprises brewing the espresso in a high-pressure brewing area of a pod cartridge; and
reducing the pressure of the espresso comprises allowing the espresso to flow from the high-pressure brewing area of the pod cartridge into an accumulation area of the pod cartridge.

13. The method of claim 9, wherein filtering the espresso comprises passing the espresso through a filter that comprises a material adapted to separate at least some of the high-cholesterol oils from the espresso.

14. The method of claim 9, wherein filtering the espresso to remove at least some high-cholesterol oils comprises allowing the espresso to descend through a filter under the force of gravity.

15. The method of claim 9, further comprising mixing the espresso with at least one other liquid to form an espresso-based beverage.

16. A pod cartridge comprising:
a sidewall that defines an interior space,
a base that separates the interior space into a brewing area and an accumulation area, the brewing area being configured for brewing espresso at a relatively high pressure and the accumulation area being configured for allowing the espresso to return to a lower pressure; and
a filter positioned in the accumulation area, the filter being configured to remove at least some high-cholesterol oils from the espresso after the pressure of the espresso has been lowered.

17. The pod cartridge of claim 16, wherein the filter is coupled to the sidewall at an end of the accumulation area opposite from the base.

18. The pod cartridge of claim 16, wherein the filter comprises a material adapted to separate at least some of the high-cholesterol oils from the espresso.

19. The pod cartridge of claim 16, wherein the accumulation area is sized to allow espresso that descends from the brewing area to return substantially to atmospheric pressure before being filtered.

20. The pod cartridge of claim 16, wherein the accumulation area is sized such that a volume of the accumulation area exceeds a volume of espresso accumulated in the accumulation area at any point in the brewing process.
